(19) United States
(12) Patent Application Publication
(10) Pub. No.: US 2022/0156871 A1
(43) Pub. Date: May 19, 2022

(54) Ranking Method of Urban Parking Lots Based on Temporal and Spatial Features and Its Device, Terminal, and Medium

(71) Applicant: SHENZHEN INSTITUTES OF ADVANCED TECHNOLOGY CHINESE ACADEMY OF SCIENCES, Shenzhen (CN)

(72) Inventors: Lei PENG, Shenzhen, Guangdong (CN); Qinghao LU, Shenzhen, Guangdong (CN)

(21) Appl. No.: 17/440,643

(22) PCT Filed: May 15, 2019
(86) PCT No.: PCT/CN2019/087081

§ 371 Date: Sep. 17, 2021

(51) Int. Cl. G06Q 50/30; G08G 1/14; G06Q 30/02; G06F 17/18

(52) U.S. Cl. CPC G06Q 50/30; G06F 17/18; G06Q 30/0283; G08G 1/144

(57) ABSTRACT

A ranking method of urban parking lots based on temporal and spatial features and its device, terminal and medium, wherein the method comprises: adopting service capability model and temporal-spatial transition model to get the initial service capability ranking of all parking lots and the transition probability matrix between parking lots at the moment based on all parking lots within the preset urban regions and their static and dynamic information; using the power iteration algorithm to iteratively calculate the comprehensive service capability ranking of all parking lots at the moment in accordance with initial service capability ranking and transition probability matrix until the stopping conditions for the iteration are met; sequencing the parking lots based on comprehensive service capability ranking, thus achieving real-time quantitative computation of service capability of any urban parking lot from the temporal and spatial dimensions

### CROSS-REFERENCE TO RELATED APPLICATION

This application is a national stage application of PCT/CN2019/087081. This application claims priority from PCT Application No. PCT/CN2019/087081, filed May 15, 2019, the content of which is incorporated herein in the entirety by reference.

### TECHNICAL FIELD

The invention falls under the computer technology field, especially involving a ranking method of urban parking lots based on temporal and spatial features and its device, terminal, and medium.

### BACKGROUND TECHNOLOGY

Due to the rapid increase in vehicle quantity, parking becomes increasingly difficult in many Chinese cities; Spending too much time in finding a parking space not only aggravates traffic but also leads to increased energy consumption, so it is imperative to tackle this serious issue for cities. To this end, a City-wide Parking Guidance System (CPGS) is introduced to guide vehicles to the surrounding parking lots with unoccupied parking spaces, thus achieving rapid and easy parking of vehicles. Just like a search engine, CPGS can transmit the information of the most related parking lots to the parking users based on the keywords they query. As a quantitative assessing and ranking technique, the ranking method is directly used for determining which pages or parking lots are the most related ones based on keywords queried, and each page gets a rank value calculated by the search engine in accordance with the keywords; the higher the rank value is, the most related the page will be; different ranking models will lead to different ranking lists. The pages with more visits on heated websites certainly have a higher ranking than those on unknown websites; even if they have similar keywords, by exchanging links with heated websites with a higher rank value, unknown websites will also experience an increase in their rank value. In fact, a similar phenomenon can be identified during the parking process. If a popular parking lot has been fully occupied, the vehicles heading for it will be parked in the parking lots nearby, so the importance of parking lots shall be evaluated to facilitate ranking computation. Current evaluation of the importance of parking lots is merely based on the analysis of geographic information from temporal or spatial dimension alone, so the evaluation results are of low accuracy; besides, the computation of rank value for parking lots is time-consuming, and the needs of parking users cannot be satisfied.

### SUMMARY OF THE INVENTION

The invention provides a ranking method of urban parking lots based on temporal and spatial features and its device, terminal, and storage medium, aiming to eliminate inaccurate sequencing of urban parking lots and low success rate of parking by users because an effective sequencing method of urban parking lots is not available based on current technologies.

On the one hand, the invention provides a ranking method of urban parking lots based on temporal and spatial features, and the said method can be explained in the following steps:

Based on public information and geographical relations, all parking lots within the preset urban regions and their static and dynamic information are acquired, wherein the said parking lot information includes static and dynamic information;

In accordance with the said static information of parking lots, a prebuilt service capability model is utilized to calculate the initial service capability of each said parking lot, and the initial service capability ranking of all said parking lots is obtained according to the said initial service capability;

Based on the static and dynamic information of the said parking lots, a prebuilt temporal-spatial transition model is utilized to get the transition probabilities between neighboring parking lots at the moment, and the transition probability matrix is thus obtained in accordance with the said transition probability;

According to the said initial service capability ranking and the said transition probability matrix, the power iteration algorithm is adopted for iterative computation of comprehensive service capability ranking of all said parking lots at the moment until the preset stopping conditions for the iteration are met; then, the said parking lots are ranked based on the said comprehensive service capability ranking.

On the other hand, the invention provides the ranking device for urban parking lots based on temporal and spatial features, and the said device consists of:

A parking lot acquisition unit, which is used for acquiring all parking lots within the preset urban regions and their static and dynamic information based on public information and geographical relations, wherein the said parking lot information includes static and dynamic information;

The first parameter acquisition unit, wherein a prebuilt service capability model is utilized to calculate the initial service capability of each said parking lot in accordance with the said static information of parking lots, and the initial service capability ranking of all said parking lots is obtained according to the said initial service capability;

The second parameter acquisition unit, wherein a prebuilt temporal-spatial transition model is utilized to get the transition probabilities between neighboring parking lots at the moment based on the static and dynamic information of the said parking lots, and the transition probability matrix is thus obtained in accordance with the said transition probability; and

A parking lot ranking unit, wherein the power iteration algorithm is adopted for iterative computation of comprehensive service capability ranking of all said parking lots at the moment according to the said initial service capability ranking and the said transition probability matrix until the preset stopping conditions for the iteration are met; then, all parking lots are ranked based on the said comprehensive service capability ranking.

On the other hand, the invention also provides an intelligent terminal, comprising a memory, a processor, and a computer program stored in the said memory and executable in the said processor, wherein the said steps for the ranking method of the above urban parking lots based on temporal and spatial features are effectuated when the said computer program is executed by the said processor.

On the other hand, the invention also provides a computer-readable storage medium in which the computer program is stored, wherein the said steps for the ranking method of the above urban parking lots based on temporal and spatial features are effectuated when the said computer program is executed by the said processor.

In this invention, the service capability model and temporal-spatial transition model are adopted to get the initial service capability ranking of all parking lots and the transition probability matrix between parking lots at the moment based on all parking lots within the preset urban regions and their static and dynamic information; the power iteration algorithm is utilized to iteratively calculate the comprehensive service capability ranking of all parking lots at the moment in accordance with initial service capability ranking and transition probability matrix until the stopping conditions for the iteration are met; the parking lots are ranked based on comprehensive service capability ranking, thus achieving real-time quantitative computation of service capability of any urban parking lot from the temporal and spatial dimensions, enhancing the assessing accuracy of parking lots' service capability and the ranking effectiveness of parking lots, and playing a key role in parking guidance and parking lot construction and assessment.

### BRIEF DESCRIPTION OF FIGURES

FIG. 1 presents the flow chart on how the ranking method of urban parking lots based on temporal and spatial features is effectuated as hereunder provided by Embodiment I of the invention;

FIG. 2 shows a schematic view of the parking lot's network topology as hereunder provided by Embodiment I of the invention;

FIG. 3 shows a schematic view of the urban parking lot ranking device based on temporal and spatial features as hereunder provided by Embodiment II of the invention; and

FIG. 4 shows a schematic view of the intelligent terminal as hereunder provided by Embodiment III of the invention.

### A DETAILED DESCRIPTION OF THE INVENTION EMBODIMENTS

In order to present the objects, technical solutions, and advantages of the invention in a more clear way, the invention is further detailed in combination with the appended drawings and embodiments below. It should be understood that specific embodiments described herein just serve the purpose of explaining the invention instead of imposing restrictions on it.

In the following part, specific embodiments are presented for a more detailed description of the invention:

### Embodiment I

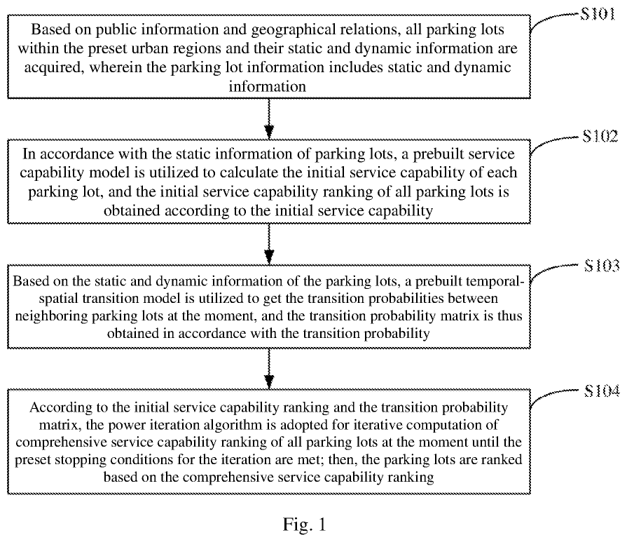

FIG. 1 gives the flow chart on how the ranking method of urban parking lots based on temporal and spatial features is effectuated as provided by Embodiment I of the invention. For clarification, only some processes regarding this embodiment of the invention are displayed, as detailed below:

In S101, based on public information and geographical relations, all parking lots within the preset urban regions and their static and dynamic information are acquired, wherein the parking lot information includes static and dynamic information.

This embodiment of the invention applies to on-board units and intelligent mobile terminals, such as on-board computers, mobile phones, smartwatches, etc. Based on public information and geographical relations (such as electronic maps), all parking lots within the preset urban regions and their static and dynamic information are acquired, wherein the parking lot information includes static and dynamic information.

Preferably, a parking lot's static information includes parking service range, the total number of parking spaces, parking prices, and geographical position; parking prices also incorporate the hourly parking prices for different vehicle models and upper limits; in contrast, a parking lot's dynamic information includes the number of parking spaces available at the moment, thus providing a basis for assessing the service capability of parking lots and enhancing the assessing accuracy of service capability.

More preferably, a parking lot's dynamic information also includes the traffic flow on the effective path from the target geographical location of the targeted vehicle to the parking lot (i.e. congestion information), thereby further enhancing the assessing accuracy of service capability.

In S102, in accordance with the static information of parking lots, a prebuilt service capability model is utilized to calculate the initial service capability of each parking lot, and the initial service capability ranking of all parking lots is obtained according to the initial service capability.

In this embodiment of the invention, the service capability of parking lots is mainly assessed from three aspects: parking service range, the total number of parking spaces, and parking prices; parking service range means which kinds of cars can be parked in this parking lot. For example, a shopping mall's parking lot is open to all kinds of vehicles, while a residential community's parking lot only serves the property owners. Relatively speaking, a parking lot with a larger service range is often found with higher service capability; a parking lot with more parking spaces in total also reveals higher service capability. Parking prices are also an important influencing factor for service capability; as a rule, the higher the parking price is, less possibly the parking lot will be chosen and fewer cars there will be; that is to say, a parking lot with higher parking prices has lower service capability, and a parking lot's service capability is embodied in its service capability ranking. Based on the static information (such as parking service range, the total number of parking spaces, parking prices) of parking lots acquired, a prebuilt service capability model can be utilized to calculate the initial service capability of each parking lot. The initial service capability ranking of all parking lots can thus be obtained in accordance with initial service capability, which is expressed as the column vector Pₜ⁰=(p₁⁰, p₂⁰, . . . , pₘ⁰)^{T}, wherein T represents the transpose of the vector; p0¹, p₂⁰, and pₘ⁰ refer to the initial service capability of the 1st, 2nd and mth parking lot, respectively; Pₜ⁰ is the initial service capability ranking of the mth parking lot at time t.

Before adopting the prebuilt service capability model for calculating the initial service capability of each parking lot, preferably, the service capability model for parking lots is constructed based on major influencing factors, which is expressed as

$${p}_{i}^{0} = exp ( {x}_{i} ) \frac{{y}_{i} \text{/} ‖ y ‖}{1 + {z}_{i} \text{/} ‖ z ‖} , ( I \leq i \leq m ) ,$$

wherein p0ᵢ is the initial service capability of the ith parking lot;

xᵢ is the parking service range of the ith parking lot; y is the total number of parking spaces for the ith parking lot, and y is the total number of parking spaces for all parking lots; zᵢ refers to the parking price of the ith parking lot, and z refers to the sum of parking prices of all parking lots; m is the quantity of all parking lots; exp(xᵢ) is the expected parking service range of the ith parking lot, thus improving the plausibility of calculating the parking lot's initial service capability.

In S103, based on the static and dynamic information of the parking lots, a prebuilt temporal-spatial transition model is utilized to get the transition probabilities between neighboring parking lots at the moment, and the transition probability matrix is thus obtained in accordance with the transition probability.

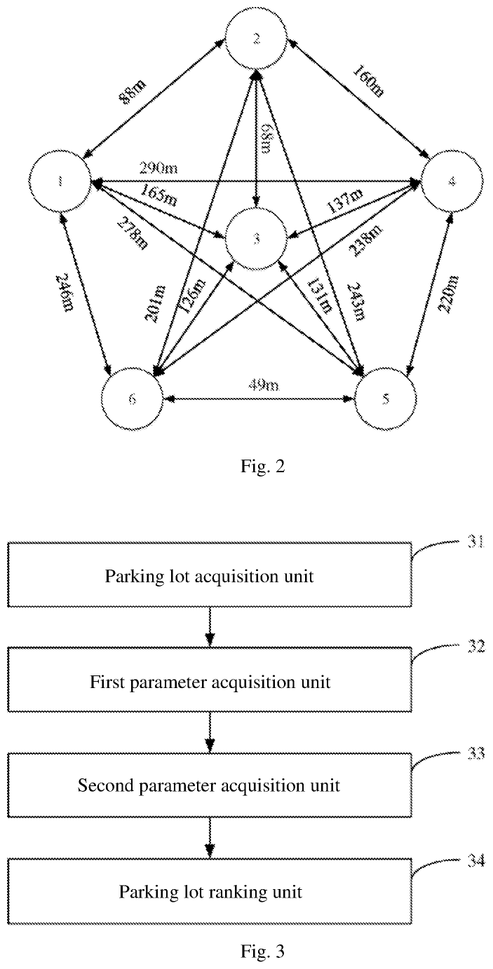

In this embodiment of the invention, the accessible distances between parking lots can be calculated based on geographical locations among static information of the parking lots; afterwards, the sparking lot network topology is constructed in accordance with accessible distances, and the prebuilt temporal-spatial transition model is adopted to get the transition probability between neighboring parking lots at the moment based on the parking lot network topology and real-time dynamic information (such as the number of parking spaces available at the moment); finally, the transition probability matrix between parking lots is obtained based on the transfer probabilities. As an example, FIG. 2 presents the network topology of a parking lot where each node represents a parking lot; the weights (for example, the weight between Node 1 and Node 2 is 88 m) on the chain represent accessible distances between parking lots.

Preferably, the transition probability model is expressed as

$${S}_{t} ( \begin{matrix}{q}_{1} & {{d}_{12}}^{*} ( 1 - {q}_{1} ) {q}_{2} & … & {{d}_{1 m}}^{*} ( 1 - {q}_{1} ) {q}_{m} \\ {{d}_{21}}^{*} ( 1 - {q}_{2} ) {q}_{1} & {q}_{2} & … & {{d}_{2 m}}^{*} ( 1 - {q}_{2} ) {q}_{m} \\ … & … & {{d}_{ij}}^{*} ( 1 - {q}_{i} ) {q}_{j} & … \\ {{d}_{m 1}}^{*} ( 1 - {q}_{m} ) {q}_{1} & {{d}_{m 2}}^{*} ( 1 - {q}_{m} ) {q}_{2} & … & {q}_{m}\end{matrix} ) ,$$

wherein Sₜ refers to the transition probability matrix between m parking lots at time t;

$${q}_{i} = \frac{{e}_{i}}{{E}_{i}} ( 1 \leq i \leq m )$$

represents the parking probability of the ith parking lot; Eᵢ means the total number of parking spaces for the ith parking lot; eᵢ refers to the number of unoccupied parking spaces currently available for the ith parking lot; dᵢⱼ(1≤i≤m, 1≤j≤m, and i≠j) refers to the influence of the distance between the ith parking lot and the jth parking lot on the transition of the targeted vehicle between them. The transition probability model not only takes into account the influencing factors on the distance between parking lots from the spatial dimension but also considers the fact that the number of unoccupied parking spaces changes with time from the temporal dimension, thus enhancing the plausibility and accuracy of transition probability between parking lots. In this case, when the targeted parking lot is fully occupied, the targeted vehicle has to find an alternative parking lot, which can be better simulated by the model. Moreover, a matrix can be utilized to represent this transition probability model, and improve the ranking efficiency of subsequent parking lots.

$${d}_{ij} = \frac{{A}_{ij}^{- 1}}{{\sum }_{1}^{m} {A}_{im}^{- 1}} {L}_{ij}$$

More preferably, dᵢⱼ can be computed through the equation wherein

$$A = ( \begin{matrix}0 & {L}_{12} & … & {L}_{ij} & … & L \text{?} \\ {L}_{21} & 0 & & & & L \text{?} \\ … & & … & & & … \\ L \text{?} & & & 0 & & L \text{?} \\ … & & & & … & … \\ {L}_{m 1} & {L}_{m 2} & … & L \text{?} & … & 0\end{matrix} )$$

$$\text{?} \text{indicates text missing or illegible when filed}$$

is the accessible matrix between m parking lots; Lᵢⱼ is the accessible distance between the ith parking lot and the jth parking lot, thus further enhancing the plausibility and accuracy of transition probability between parking lots.

In S104, according to the initial service capability ranking and the transition probability matrix, the power iteration algorithm is adopted for iterative computation of comprehensive service capability ranking of all parking lots at the moment until the preset stopping conditions for the iteration are met; then, the parking lots are ranked based on the comprehensive service capability ranking.

In this embodiment of the invention, based on the initial service capability ranking P₁⁰=(p₁⁰, p₂⁰, . . . , pₘ⁰)^{T}, the transition probability matrix Sₜ and the simultaneous equations

$$\{ \begin{matrix}{P}_{t}^{n + 1} = {S}_{t}^{T} {P}_{t}^{n} \\ {P}_{t}^{n} = {P}_{1}^{0} , {P}_{2}^{0} , … {P}_{m}^{0} ) \text{?} ,\end{matrix} \\ \text{?} \text{indicates text missing or illegible when filed}$$

the power iteration algorithm is adopted for iterative calculation of comprehensive service capability of all parking lots at the moment until the preset iteration stopping condition |Pₜⁿ⁺¹−Pₙt|<ε is met; afterward, the service capabilities of the parking lots are ranked from highest to lowest or from lowest to highest based on the comprehensive service capability ranking, wherein ε is the preset sufficiently-small number for characterizing the convergence of iteration results; n is the number of iterations; Pₙ t refers to the comprehensive service capability ranking obtained from the nth iteration at time t.

In this embodiment of this invention, the service capability model and temporal-spatial transition model are adopted to get the initial service capability ranking of all parking lots and the transition probability matrix between parking lots at the moment based on all parking lots within the preset urban regions and their static and dynamic information; the power iteration algorithm is utilized to iteratively calculate the comprehensive service capability ranking of all parking lots at the moment in accordance with initial service capability ranking and transition probability matrix until the stopping conditions for the iteration are met; the parking lots are ranked based on comprehensive service capability ranking, thus achieving real-time quantitative computation and comparison of service capability of any urban parking lot at any time from the temporal and spatial dimensions, enhancing the assessing accuracy of parking lots' service capability, the computational efficiency of the parking lots' ranking and the ranking effectiveness of parking lots, playing a key role in parking guidance and parking lot construction and assessment, and increasing the success rate of parking by users.

### Embodiment II

FIG. 3 gives the structure of the ranking device for urban parking lots based on temporal and spatial features as provided by Embodiment II of the invention. For clarification, only some components regarding this embodiment of the invention are displayed, comprising of:

A parking lot acquisition unit 31, which is used for acquiring all parking lots within the preset urban regions and their static and dynamic information based on public information and geographical relations, wherein the parking lot information includes static and dynamic information.

This embodiment of the invention applies to on-board units and intelligent mobile terminals, such as on-board computers, mobile phones, smartwatches, etc. Based on public information and geographical relations (such as electronic maps), all parking lots within the preset urban regions and their static and dynamic information are acquired, wherein the parking lot information includes static and dynamic information.

Preferably, a parking lot's static information includes parking service range, the total number of parking spaces, parking prices, and geographical position; parking prices also incorporate the hourly parking prices for different vehicle models and upper limits; in contrast, a parking lot's dynamic information includes the number of parking spaces available at the moment, thus providing a basis for assessing the service capability of parking lots and enhancing the assessing accuracy of service capability.

More preferably, a parking lot's dynamic information also includes the traffic flow on the effective path from the target geographical location of the targeted vehicle to the parking lot (i.e. congestion information), thereby further enhancing the assessing accuracy of service capability.

The first parameter acquisition unit 32, wherein a prebuilt service capability model is utilized to calculate the initial service capability of each parking lot in accordance with the static information of parking lots, and the initial service capability ranking of all parking lots is obtained according to the initial service capability.

In this embodiment of the invention, the service capability of parking lots is mainly assessed from three aspects: parking service range, the total number of parking spaces, and parking prices; parking service range means which kinds of cars can be parked in this parking lot. For example, a shopping mall's parking lot is open to all kinds of vehicles, while a residential community's parking lot only serves the property owners. Relatively speaking, a parking lot with a larger service range is often found with higher service capability; a parking lot with more parking spaces in total also reveals higher service capability. Parking prices are also an important influencing factor for service capability; as a rule, the higher the parking price is, less possibly the parking lot will be chosen and fewer cars there will be; that is to say, a parking lot with higher parking prices has lower service capability, and a parking lot's service capability is embodied in its service capability ranking Based on the static information (such as parking service range, the total number of parking spaces, parking prices) of parking lots acquired, a prebuilt service capability model can be utilized to calculate the initial service capability of each parking lot. The initial service capability ranking of all parking lots can thus be obtained in accordance with initial service capability, which is expressed as the column vector Pₜ⁰=(p₁⁰, p₂⁰, . . . , pₘ⁰)^{T}, wherein T represents the transpose of the vector; p₁⁰, p₂⁰, and pₘ⁰ refer to the initial service capability of the 1st, 2nd and mth parking lot, respectively; Pₜ⁰ is the initial service capability ranking of the mth parking lot at time t.

Before adopting the prebuilt service capability model for calculating the initial service capability of each parking lot, preferably, the service capability model for parking lots is constructed based on major influencing factors, which is expressed as

$${P}_{i}^{0} = exp ( {x}_{i} ) \frac{{y}_{i} \text{/} ‖ y ‖}{1 + {z}_{i} \text{/} ‖ z ‖} , ( 1 \leq i \leq m ) ,$$

wherein p0ᵢ is the initial service capability of the ith parking lot;

xᵢ is the parking service range of the ith parking lot; yᵢ is the total number of parking spaces for the ith parking lot, and y is the total number of parking spaces for all parking lots; zᵢ refers to the parking price of the ith parking lot, and z refers to the sum of parking prices of all parking lots; m is the quantity of all parking lots; exp(xᵢ) is the expected parking service range of the ith parking lot, thus improving the plausibility of calculating the parking lot's initial service capability.

The second parameter acquisition unit 33, wherein a prebuilt temporal-spatial transition model is utilized to get the transition probabilities between neighboring parking lots at the moment based on the static and dynamic information of the parking lots, and the transition probability matrix is thus obtained in accordance with the transition probability.

In this embodiment of the invention, the accessible distances between parking lots can be calculated based on geographical locations among static information of the parking lots; afterwards, the sparking lot network topology is constructed in accordance with accessible distances, and the prebuilt temporal-spatial transition model is adopted to get the transition probability between neighboring parking lots at the moment based on the parking lot network topology and real-time dynamic information (such as the number of parking spaces available at the moment); finally, the transition probability matrix between parking lots is obtained based on the transfer probabilities.

Preferably, the transition probability model is expressed as

$${S}_{i} ( \begin{matrix}{q}_{1} & {{d}_{12}}^{*} ( 1 - {q}_{1} ) {q}_{2} & … & {{d}_{1 m}}^{*} ( 1 - {q}_{1} ) {q}_{m} \\ {{d}_{21}}^{*} ( 1 - {q}_{2} ) {q}_{1} & {q}_{2} & … & {{d}_{2 m}}^{*} ( 1 - {q}_{2} ) {q}_{m} \\ … & … & {{d}_{ij}}^{*} ( 1 - {q}_{i} ) {q}_{j} & … \\ {{d}_{m 1}}^{*} ( 1 - {q}_{m} ) {q}_{1} & {{d}_{m 2}}^{*} ( 1 - {q}_{m} ) {q}_{2} & … & {q}_{m}\end{matrix} ) ,$$

wherein Sₜ refers to the transition probability matrix between m parking lots at time t;

$${q}_{i} = \frac{{e}_{i}}{{E}_{i}} ( 1 \leq i \leq m )$$

represents the parking probability of the ith parking lot; Eᵢ means the total number of parking spaces for the ith parking lot; eᵢ refers to the number of unoccupied parking spaces currently available for the ith parking lot; dᵢⱼ(1≤i≤m, 1≤i≤m, and i≠j) refers to the influence of the distance between the ith parking lot and the jth parking lot on the transition of the targeted vehicle between them. The transition probability model not only takes into account the influencing factors on the distance between parking lots from the spatial dimension but also considers the fact that the number of unoccupied parking spaces changes with time from the temporal dimension, thus enhancing the plausibility and accuracy of transition probability between parking lots. In this case, when the targeted parking lot is fully occupied, the targeted vehicle has to find an alternative parking lot, which can be better simulated by the model. Moreover, a matrix can be utilized to represent this transition probability model, and improve the ranking efficiency of subsequent parking lots.

$${d}_{ij} = \frac{{A}_{ij}^{- 1}}{{\sum }_{1}^{m} {A}_{im}^{- 1}} {L}_{ij}$$

More preferably, dᵢⱼ can be computed through the equation wherein

$$A = ( \begin{matrix}0 & {L}_{12} & … & {L}_{1 j} & … & {L}_{1 m} \\ {L}_{21} & 0 & & & & {L}_{2 m} \\ … & & … & & & … \\ L \text{?} & & & 0 & & {L}_{im} \\ … & & & & … & … \\ {L}_{m 1} & {L}_{m 2} & … & {L}_{mj} & … & 0\end{matrix} )$$

$$\text{?} \text{indicates text missing or illegible when filed}$$

is the accessible matrix between m parking lots; Lᵢⱼ is the accessible distance between the ith parking lot and the jth parking lot, thus further enhancing the plausibility and accuracy of transition probability between parking lots.

The parking lot ranking unit 34, wherein the power iteration algorithm is adopted for iterative computation of comprehensive service capability ranking of all parking lots at the moment until the preset stopping conditions for the iteration are met according to the initial service capability ranking and the transition probability matrix; then, the parking lots are ranked based on the comprehensive service capability ranking.

In this embodiment of the invention, based on the initial service capability ranking Pₜ⁰=(p₁⁰, p₂⁰, . . . , pₘ⁰)^{T}, the transition probability matrix Sₜ and the simultaneous equations

$$\{ \begin{matrix}{P}_{t}^{n + l} = {S}_{t}^{T} {P}_{t}^{n} \\ {P}_{t}^{0} = {( {P}_{1}^{0} , {P}_{2}^{0} , … , {P}_{m}^{0} )}^{T} ,\end{matrix}$$

the power iteration algorithm is adopted for iterative calculation of comprehensive service capability of all parking lots at the moment until the preset iteration stopping condition |Pₜⁿ⁺¹−Pₙ t|<ε is met; afterwards, the service capabilities of the parking lots are ranked from highest to lowest or from lowest to highest based on the comprehensive service capability ranking, wherein ε is the preset sufficiently-small number for characterizing the convergence of iteration results; n is the number of iterations; Pₙ t refers to the comprehensive service capability ranking obtained from the nth iteration at time t.

In this embodiment of the invention, various units of the ranking device for urban parking lots based on temporal and spatial features can be achieved through corresponding hardware or software units, while various units can serve as independent software or hardware units or can be integrated into a software and hardware unit, wherein the invention is not restricted in this respect.

### Embodiment III

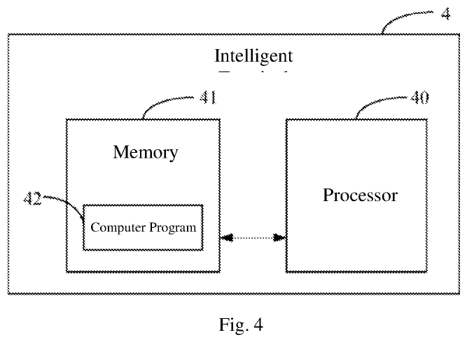

FIG. 4 shows a schematic view of the intelligent terminal as provided in Embodiment III of the invention. For clarification, only some parts regarding this embodiment of the invention are displayed.

In this embodiment of the invention, the intelligent terminal 4 consists of a processor 40, a memory 41, and a computer program 42 stored in the memory 41 and executable on the processor 40. When processor 40 executes the computer program 42, the steps in the above embodiments of the ranking method for urban parking lots based on temporal and spatial features are effectuated, such as S101 to S104 in FIG. 1. Alternatively, when processor 40 executes the computer program 42, the functions of various units in the above device embodiments are effectuated, such as the functions of Units 31-34 in FIG. 3.

In this embodiment of this invention, the service capability model and temporal-spatial transition model are adopted to get the initial service capability ranking of all parking lots and the transition probability matrix between parking lots at the moment based on all parking lots within the preset urban regions and their static and dynamic information; the power iteration algorithm is utilized to iteratively calculate the comprehensive service capability ranking of all parking lots at the moment in accordance with initial service capability ranking and transition probability matrix until the stopping conditions for the iteration are met; the parking lots are ranked based on comprehensive service capability ranking, thus achieving real-time quantitative computation and comparison of service capability of any urban parking lot at any time from the temporal and spatial dimensions, enhancing the assessing accuracy of parking lots' service capability and the ranking effectiveness of parking lots, playing a key role in parking guidance and parking lot construction and assessment, and increasing the success rate of parking by users.

Intelligent terminals in this embodiment of the invention can be on-board computers, mobile phones, smartwatches, etc. When the processor 40 in the intelligent terminal 4 executes the computer program 42, the steps of effectuating the ranking method for urban parking lots based on temporal and spatial features have been described in the above method embodiments, and will not be further elaborated here.

### Embodiment IV

In this embodiment of the invention, a computer-readable storage medium is presented, provided with a computer program. When the computer program is executed by the processor, the steps in the ranking method embodiments for urban parking lots based on temporal and spatial features are effectuated, such as S101 to S104 in FIG. 1. Alternatively, when the computer program is executed by the processor, the functions of various units in the hereinbefore device embodiments are effectuated, such as the functions of Units 31-34 in FIG. 3.

In this embodiment of this invention, the service capability model and temporal-spatial transition model are adopted to get the initial service capability ranking of all parking lots and the transition probability matrix between parking lots at the moment based on all parking lots within the preset urban regions and their static and dynamic information; the power iteration algorithm is utilized to iteratively calculate the comprehensive service capability ranking of all parking lots at the moment in accordance with initial service capability ranking and transition probability matrix until the stopping conditions for the iteration are met; the parking lots are ranked based on comprehensive service capability ranking, thus achieving real-time quantitative computation and comparison of service capability of any urban parking lot at any time from the temporal and spatial dimensions, enhancing the assessing accuracy of parking lots' service capability and the ranking effectiveness of parking lots, playing a key role in parking guidance and parking lot construction and assessment, and increasing the success rate of parking by users.

In this embodiment of the invention, the computer-readable storage medium comprises any physical device or recording medium, such as ROM/RAM, disc, compact disc, flash memory, and other memories.

The said embodiments just represent the best embodiments of this invention, but do not serve the purpose of restricting this invention; any revision, equivalent replacement, or improvement made within the spirit and principle of this invention is included in the protection scope of this invention.

1. A ranking method of urban parking lots based on temporal and spatial features, characterized in that the said method comprises of the following steps:
Based on public information and geographical relations, all parking lots within the preset urban regions and their static and dynamic information are acquired, wherein the said parking lot information includes static and dynamic information;
In accordance with the said static information of parking lots, a prebuilt service capability model is utilized to calculate the initial service capability of each said parking lot, and the initial service capability ranking of all said parking lots is obtained according to the said initial service capability;
Based on the static and dynamic information of the said parking lots, a prebuilt temporal-spatial transition model is utilized to get the transition probabilities between neighboring parking lots at the moment, and the transition probability matrix is thus obtained in accordance with the said transition probability;
According to the said initial service capability ranking and the said transition probability matrix, the power iteration algorithm is adopted for iterative computation of comprehensive service capability ranking of all said parking lots at the moment until the preset stopping conditions for the iteration are met; then, the said parking lots are ranked based on the said comprehensive service capability ranking.

2. A method as claimed in claim 1, characterized in that the static information of the said parking lot comprises of parking service range, the total number of parking spaces, parking prices and geographical locations of parking lots, and the dynamic information of the said parking lot includes the number of unoccupied parking spaces currently available.

3. A method as claimed in claim 2, characterized in that the said service capability model is expressed as
$${p}_{i}^{0} = exp ( {x}_{i} ) \frac{{y}_{i} \text{/} ‖ y ‖}{1 + {z}_{i} \text{/} ‖ z ‖} ( 1 \leq i \leq m ) ,$$
wherein p0ᵢ is the said initial service capability of the said ith parking lot; xᵢ is the said parking service range of the said ith parking lot; yᵢ is the total number of the said parking spaces of the said ith parking lot; y is the total number of the said parking spaces of all said parking lots; zᵢ is the said parking price of the said ith parking lot; z is the sum of the said parking prices of all said parking lots; m is the quantity of all said parking lots.

4. A method as claimed in claim 2, characterized in that the said transition probability model is expressed as
$${S}_{t} = ( \begin{matrix}{q}_{1} & {{d}_{12}}^{*} ( 1 - {q}_{1} ) {q}_{2} & … & {{d}_{1 m}}^{*} ( 1 - {q}_{1} ) {q}_{m} \\ {{d}_{21}}^{*} ( 1 - {q}_{2} ) {q}_{1} & {q}_{2} & … & {{d}_{2 m}}^{*} ( 1 - {q}_{2} ) {q}_{m} \\ … & … & {{d}_{ij}}^{*} ( 1 - {q}_{i} ) {q}_{j} & … \\ {{d}_{m 1}}^{*} ( 1 - {q}_{m} ) {q}_{1} & {{d}_{m2}}^{*} ( 1 - {q}_{m} ) {q}_{2} & … & {q}_{m}\end{matrix} ) ,$$
wherein Sₜ represents the transition probability matrix between m parking lots at time t;
$${q}_{i} = \frac{{e}_{i}}{{E}_{i}} ( 1 \leq i \leq m )$$
refers to the parking probability of the said ith parking lot; Eᵢ means the total number of said parking spaces of the said ith parking lot; eᵢ refers to the number of said unoccupied parking spaces currently available for the said ith parking lot; dᵢⱼ(1≤i≤m, 1≤j≤m) refers to the influence of the distance between the said ith parking lot and the said jth parking lot on the transition of the targeted vehicle between them.

5. A ranking device of urban parking lots based on temporal and spatial features, characterized in that the said device comprises of:
A parking lot acquisition unit, which is used for acquiring all parking lots within the preset urban regions and their static and dynamic information based on public information and geographical relations, wherein the said parking lot information includes static and dynamic information;
The first parameter acquisition unit, wherein a prebuilt service capability model is utilized to calculate the initial service capability of each said parking lot in accordance with the said static information of parking lots, and the initial service capability ranking of all said parking lots is obtained according to the said initial service capability;
The second parameter acquisition unit, wherein a prebuilt temporal-spatial transition model is utilized to get the transition probabilities between neighboring parking lots at the moment based on the static and dynamic information of the said parking lots, and the transition probability matrix is thus obtained in accordance with the said transition probability; and
A parking lot ranking unit, wherein the power iteration algorithm is adopted for iterative computation of comprehensive service capability ranking of all said parking lots at the moment according to the said initial service capability ranking and the said transition probability matrix until the preset stopping conditions for the iteration are met; then, the said parking lots are ranked based on the said comprehensive service capability ranking.

6. A device as claimed in claimed 5, characterized in that the static information of the said parking lot includes parking service range, the total number of parking spaces, parking prices, and geographical locations of parking lots; the dynamic information of the said parking lot includes the number of unoccupied parking spaces currently available.

7. A device as claimed in claim 6, characterized in that the said service capability model is expressed as
$${p}_{i}^{0} = exp ( {x}_{i} ) \frac{{y}_{i} / ‖ y ‖}{1 + {z}_{i} \text{/} ‖ z ‖} , ( 1 \leq i \leq m ) ,$$
wherein p0ᵢ is the said initial service capability of the said ith parking lot; xᵢ is the said parking service range of the said ith parking lot; yᵢ is the total number of said parking spaces for the said ith parking lot; y is the total number of said parking spaces for all said parking lots; zᵢ is the said parking price of the said ith parking lot; z is the sum of said parking prices of all said parking lots; m is the quantity of all said parking lots.

8. A device as claimed in claim 6, characterized in that the said transition probability model is expressed as
$${S}_{t} = ( \begin{matrix}{q}_{1} & {{d}_{12}}^{*} ( 1 - {q}_{1} ) {q}_{2} & … & {{d}_{1 m}}^{*} ( 1 - {q}_{1} ) {q}_{m} \\ {{d}_{21}}^{*} ( 1 - {q}_{2} ) {q}_{1} & {q}_{2} & … & {{d}_{2 m}}^{*} ( 1 - {q}_{2} ) {q}_{m} \\ … & … & {{d}_{ij}}^{*} ( 1 - {q}_{i} ) {q}_{j} & … \\ {{d}_{m 1}}^{*} ( 1 - {q}_{m} ) {q}_{1} & {{d}_{m2}}^{*} ( 1 - {q}_{m} ) {q}_{2} & … & {q}_{m}\end{matrix} ) ,$$
wherein Sₜ represents the transition probability matrix between m parking lots at time t;
$${q}_{i} = \frac{{e}_{i}}{{E}_{i}} ( 1 \leq i \leq m )$$
refers to the parking probability of the said ith parking lot; Eᵢ means the total number of said parking spaces for the said ith parking lot; eᵢ refers to the number of unoccupied parking spaces currently available; dᵢⱼ(1≤i≤m, 1≤j≤m) refers to the influence of the distance between the said ith parking lot and the said jth parking lot on the transition of the targeted vehicle between them.

9. An intelligent terminal, comprising a memory, a processor, and a computer program stored in the said memory and executed in the said processor, characterized in that the steps as claimed in claim 1 is effectuated when the said computer program is executed by the said processor.

10. A computer-readable storage medium in which the computer program is stored, characterized in that the steps as claimed in claim 1 is effectuated when the said computer program is executed by the said processor.

11. The intelligent terminal, comprising a memory, a processor, and a computer program stored in the said memory and executed in the said processor, characterized in that the steps as claimed in claim 9, wherein the static information of the said parking lot comprises of parking service range, the total number of parking spaces, parking prices and geographical locations of parking lots, and the dynamic information of the said parking lot includes the number of unoccupied parking spaces currently available.

12. The intelligent terminal, comprising a memory, a processor, and a computer program stored in the said memory and executed in the said processor, characterized in that the steps as claimed in claim 9, wherein the said service capability model is expressed as
$${p}_{i}^{0} = exp ( {x}_{i} ) \frac{{y}_{i} / ‖ y ‖}{1 + {z}_{i} \text{/} ‖ z ‖} ( 1 \leq i \leq m ) ,$$
wherein p0ᵢ is the said initial service capability of the said ith parking lot; xᵢ is the said parking service range of the said ith parking lot; yᵢ is the total number of the said parking spaces of the said ith parking lot; y is the total number of the said parking spaces of all said parking lots; zᵢ is the said parking price of the said ith parking lot; z is the sum of the said parking prices of all said parking lots; m is the quantity of all said parking lots.

13. The intelligent terminal, comprising a memory, a processor, and a computer program stored in the said memory and executed in the said processor, characterized in that the steps as claimed in claim 9, wherein the said transition probability model is expressed as
$${S}_{t} = ( \begin{matrix}{q}_{1} & {{d}_{12}}^{*} ( 1 - {q}_{1} ) {q}_{2} & … & {{d}_{1 m}}^{*} ( 1 - {q}_{1} ) {q}_{m} \\ {{d}_{21}}^{*} ( 1 - {q}_{2} ) {q}_{1} & {q}_{2} & … & {{d}_{2 m}}^{*} ( 1 - {q}_{2} ) {q}_{m} \\ … & … & {{d}_{ij}}^{*} ( 1 - {q}_{i} ) {q}_{j} & … \\ {{d}_{m 1}}^{*} ( 1 - {q}_{m} ) {q}_{1} & {{d}_{m2}}^{*} ( 1 - {q}_{m} ) {q}_{2} & … & {q}_{m}\end{matrix} ) ,$$
wherein Sₜ represents the transition probability matrix between m parking lots at time t;
$${q}_{i} = \frac{{e}_{i}}{{E}_{i}} ( 1 \leq i \leq m )$$
refers to the parking probability of the said ith parking lot; Eᵢ means the total number of said parking spaces of the said ith parking lot; eᵢ refers to the number of said unoccupied parking spaces currently available for the said ith parking lot; dᵢⱼ(1≤i≤m, 1≤j≤m) refers to the influence of the distance between the said ith parking lot and the said jth parking lot on the transition of the targeted vehicle between them.

14. The computer-readable storage medium in which the computer program is stored, characterized in that the steps as claimed in claim 10, wherein the static information of the said parking lot comprises of parking service range, the total number of parking spaces, parking prices and geographical locations of parking lots, and the dynamic information of the said parking lot includes the number of unoccupied parking spaces currently available.

15. The computer-readable storage medium in which the computer program is stored, characterized in that the steps as claimed in claim 10, wherein the said service capability model is expressed as
$${p}_{i}^{0} = exp ( {x}_{i} ) \frac{{y}_{i} / ‖ y ‖}{1 + {z}_{i} / ‖ z ‖} ( 1 \leq i \leq m ) ,$$
wherein p0ᵢ is the said initial service capability of the said ith parking lot; xᵢ is the said parking service range of the said ith parking lot; yᵢ is the total number of the said parking spaces of the said ith parking lot; y is the total number of the said parking spaces of all said parking lots; zᵢ is the said parking price of the said ith parking lot; z is the sum of the said parking prices of all said parking lots; m is the quantity of all said parking lots.

16. The computer-readable storage medium in which the computer program is stored, characterized in that the steps as claimed in claim 10, wherein the said transition probability model is expressed as
$${S}_{t} = ( \begin{matrix}{q}_{1} & {{d}_{12}}^{*} ( 1 - {q}_{1} ) {q}_{2} & … & {{d}_{1 m}}^{*} ( 1 - {q}_{1} ) {q}_{m} \\ {{d}_{21}}^{*} ( 1 - {q}_{2} ) {q}_{1} & {q}_{2} & … & {{d}_{2 m}}^{*} ( 1 - {q}_{2} ) {q}_{m} \\ … & … & {{d}_{ij}}^{*} ( 1 - {q}_{i} ) {q}_{j} & … \\ {{d}_{m 1}}^{*} ( 1 - {q}_{m} ) {q}_{1} & {{d}_{m2}}^{*} ( 1 - {q}_{m} ) {q}_{2} & … & {q}_{m}\end{matrix} ) ,$$
wherein Sₜ represents the transition probability matrix between m parking lots at time t;
$${q}_{i} = \frac{{e}_{i}}{{E}_{i}} ( 1 \leq i \leq m )$$
refers to the parking probability of the said ith parking lot; Eᵢ means the total number of said parking spaces of the said ith parking lot; eᵢ refers to the number of said unoccupied parking spaces currently available for the said ith parking lot; dᵢⱼ(1≤i≤m, 1≤j≤m) refers to the influence of the distance between the said ith parking lot and the said jth parking lot on the transition of the targeted vehicle between them.
